(19) United States
(12) Patent Application Publication
(10) Pub. No.: US 2026/0324661 A1
(43) Pub. Date: Oct. 22, 2026

(54) ELECTRIC SMOKING OVEN WITH INDEPENDENT SMOKE CONTROL

(71) Applicant: Zhejiang Fudeer Electric Appliance Co., Ltd., Taizhou (CN)

(72) Inventors: Meide JIANG, Taizhou (CN); Junhua JIANG, Taizhou (CN)

(21) Appl. No.: 19/180,287

(22) Filed: Apr. 16, 2025

(51) Int. Cl. A23B 4/052; A47J 37/07

(52) U.S. Cl. CPC A23B 4/052; A47J 37/0722; A47J 37/0786

(57) ABSTRACT

An electric smoking oven with independent smoke control includes an oven body, a heating tube for smoking, a heating tube for roasting, a smoking box and a plurality of grills, the oven body has a roasting chamber, the plurality of grills are connected to an inner wall of the roasting chamber at intervals, the heating tube for roasting and the heating tube for smoking are connected to the inner wall of the roasting chamber at intervals, a heating end of the heating tube for roasting faces the plurality of grills to heat food on the plurality of grills, and a heating end of the heating tube for smoking is connected to the smoking box to heat a smoke-producing material in the smoking box.

### TECHNICAL FIELD

The present application relates to the field of outdoor smoking ovens, and in particular, to an electric smoking oven with independent smoke control.

### BACKGROUND ART

The electric smoking oven is a widely used apparatus in the food industry, of which a heating tube is used for heating to generate smoke and smoke food, mainly to enhance the flavor and color of food.

In the use of the electric smoking oven, smoking and roasting must be performed at the same time, but the electric smoking oven has only one set of heating tubes, so the user cannot adjust the smoke initiation timing of smoking and the amount of smoke output in the roasting process, resulting in uneven amount of smoke in the electric smoking oven in the whole roasting process, thus affecting the taste of food.

### SUMMARY

In order to improve the problem that a user cannot adjust the smoke initiation timing and the amount of smoke output in a roasting process, the present application provides an electric smoking oven with independent smoke control.

The present application provides an electric smoking oven with independent smoke control, including an oven body, a heating tube for smoking, a heating tube for roasting, a smoking box and a plurality of grills, the oven body has a roasting chamber, the plurality of grills are connected to an inner wall of the roasting chamber at intervals, the heating tube for roasting and the heating tube for smoking are connected to the inner wall of the roasting chamber at intervals, a heating end of the heating tube for roasting faces the plurality of grills to heat food on the plurality of grills, and a heating end of the heating tube for smoking is connected to the smoking box to heat a smoke-producing material in the smoking box.

By adopting the above-mentioned technical solution, when it is necessary to use an electric smoking oven, food is firstly placed on a surface of the plurality of grills in sequence, the smoke-producing material is placed in the smoking box, the temperature of the heating tube for roasting is adjusted according to the temperature required by cooking the food, and the temperature of the heating tube for smoking is adjusted according to the start time required for smoking and the amount of smoke output, so as to precisely control the smoke initiation timing and the amount of the smoke output in the food roasting process, and ensure a uniform amount of smoke output in the whole roasting process, thereby improving the roasting taste of the food.

Optionally, the oven body is connected with a control assembly including a control panel and a temperature sensor, the control panel is connected to a surface of the oven body, the control panel is electrically connected to the heating tube for smoking to set smoking time and control on/off switching and a heating temperature of the heating tube for smoking, the temperature sensor is connected to the inner wall of the roasting chamber, a detection end of the temperature sensor abuts against an outer wall of the smoking box, the temperature sensor is electrically connected to the control panel, and the temperature sensor is configured for detecting a temperature of the smoking box in real time and transmitting the temperature of the smoking box to the control panel.

By adopting the above-mentioned technical solution, when the electric smoking oven is in use, a smoking time required for the food is set on the control panel, the control panel controls the heating tube for smoking to start up, to heat the smoking box, so that the smoke-producing material in the smoking box is heated to generate smoke, so as to smoke the food on the grills. At the same time, the detection end of the temperature sensor abuts against the outer wall of the smoking box, to detect the temperature of the smoking box in real time and transmits it to the control panel, and the control panel adjusts the temperature of the heating tube for smoking according to the temperature of the smoking box to achieve a stable smoke concentration in the roasting chamber, thereby improving the roasting flavor of the food.

Optionally, a meat temperature probe connector is connected to a surface of the oven body, and a detection end of a meat temperature probe is inserted into the meat temperature probe connector to measure an internal temperature of the food.

By adopting the above-mentioned technical solution, when it is necessary to monitor the temperature of the food on the grills, the detection end of the meat temperature probe is inserted into the meat temperature probe connector to measure the internal temperature of the food in real time, so that the user can more accurately and intuitively observe doneness of the food on the grills.

Optionally, a maintenance chamber is formed in a side wall of the oven body, the maintenance chamber communicates with the roasting chamber and faces the heating tube for roasting and the heating tube for smoking, and a heating tube rear cover is fixed on a surface of the oven body via a bolt for covering the maintenance chamber.

By adopting the above-mentioned technical solution, when it is necessary to repair and replace the heating tube for roasting or the heating tube for smoking, the bolt is unscrewed, to remove the heating tube rear cover from the oven body, thereby facilitating the repair and replacement of the heating tube for roasting and the heating tube for smoking in the roasting chamber, and thus extending the service life of the oven body.

Optionally, an adjustment plate is rotatably connected to a surface of the oven body, the oven body is configured with a plurality of exhaust vents at intervals around a rotation axis of the adjustment plate, the plurality of exhaust vents communicate with the roasting chamber, the adjustment plate is configured with a plurality of adjustment ports at intervals around the rotation axis of the adjustment plate, and the plurality of adjustment ports extend through the adjustment plate and communicate with the plurality of exhaust vents.

By adopting the above-mentioned technical solution, the air in the roasting chamber is discharged from the adjustment port through the exhaust vent. When it is necessary to adjust the exhaust flow rate of the oven body, the adjustment plate is driven to rotate, so that the communication area between the exhaust vent and the adjustment port changes, to vary the exhaust flow rate of the oven body, thereby further improving the roasting taste of the food.

Optionally, the oven body is connected with an oil storage assembly including a greasy dirt collection box, a sliding chamber is formed in the oven body, the greasy dirt collection box is slidable in the sliding chamber, an oil discharge hole is formed in a bottom wall of the roasting chamber facing the plurality of grills, the oil discharge hole communicates with the sliding chamber, a box opening of the greasy dirt collection box faces the oil discharge hole, and the oil discharge hole and the box opening of the greasy dirt collection box are so configured, that greasy dirt of the food on the plurality of grills enters the greasy dirt collection box through the oil discharge hole and the box opening of the greasy dirt collection box.

By adopting the above-mentioned technical solution, when the electric smoking oven is in use, the greasy dirt of the food on the grills enters the greasy dirt collection box via the oil discharge hole and the box opening of the greasy dirt collection box, so as to realize a collection of the greasy dirt. When the greasy dirt collection box needs to be cleaned, the greasy dirt collection box is driven to slide along the inner wall of the sliding chamber in a direction away from the oil discharge hole, so that the greasy dirt collection box is separated from the oven body, thereby facilitating the cleaning of the greasy dirt collection box.

Optionally, the oil storage assembly further includes an oil guide plate and a water basin, the oil guide plate is connected to the inner wall of the roasting chamber, the oil guide plate is located on a side of the heating tube for roasting facing the plurality of grills, the oil guide plate is configured with an oil guide hole extending through the oil guide plate, the water basin is slidably connected to a first plate surface of the oil guide plate facing the heating tube for roasting, a basin opening of the water basin faces the oil guide hole, and the water basin and the oil guide hole are so configured, that the greasy dirt of the food on the plurality of grills enters the water basin through the oil guide hole along a second plate surface of the oil guide plate, and after the greasy dirt accumulated in the water basin overflows, the greasy dirt enters the greasy dirt collection box via the oil discharge hole and the box opening of the greasy dirt collection box.

By adopting the above-mentioned technical solution, the greasy dirt of the food on the grills enters the water basin through the oil guide hole along the plate surface of the oil guide plate, the oil accumulates on the water surface in the water basin, and after the greasy dirt accumulated in the water basin overflows, the greasy dirt enters the greasy dirt collection box via the oil discharge hole and the box opening of the greasy dirt collection box, achieving stable collection of the greasy dirt.

Optionally, the second plate surface of the oil guide plate facing the plurality of grills is further formed with an oil guide surface, and the oil guide surface flares outward in an axial direction of the oil guide hole for guiding the greasy dirt into the oil guide hole.

By adopting the above-mentioned technical solution, the oil guide surface flares outward in the axial direction of the oil guide hole, whereby the greasy dirt is guided into the oil guide hole, so that the greasy dirt is less likely to accumulate on the oil guide surface, thereby further improving the collection efficiency of the greasy dirt.

Optionally, the bottom wall of the roasting chamber is further formed with a buffer surface, and the buffer surface flares outward in an axial direction of the oil discharge hole for guiding the greasy dirt into the oil discharge hole.

By adopting the above-mentioned technical solution, the buffer surface flares outward along the axial direction of the oil discharge hole. When the greasy dirt in the water basin overflows onto the buffer surface, the buffer surface guides the greasy dirt into the oil discharge hole so that the greasy dirt does not easily remain on the buffer surface, thereby improving the collection efficiency of the greasy dirt.

Optionally, a tool box is slidably connected to a surface of the oven body, and an inner cavity of the tool box is configured for storing a tool.

By adopting the above-mentioned technical solution, the user places the tool to be used in the tool box, and the tool box slides on the surface of the oven body, thereby facilitating the user to take the tool in the tool box.

In summary, the present application includes at least one of the following beneficial technical effects:
1. The heating tube for roasting and the heating tube for smoking are respectively provided, so that the temperature of the heating tube for roasting is adjustable according to the start time required for smoking and the amount of smoke output, so as to precisely control the smoke initiation timing and the amount of the smoke output in the food roasting process, and ensure a uniform amount of smoke output in the whole roasting process, thereby improving the roasting taste of the food.
2. The temperature sensor detects the temperature of the smoking box in real time and transmits it to the control panel, so that the control panel adjusts the temperature of the heating tube for smoking according to the temperature of the smoking box to achieve a stable smoke concentration in the roasting chamber, thereby improving the roasting flavor of the food.
3. The detection end of the meat temperature probe is inserted into the meat temperature probe connector to measure the internal temperature of the food in real time, so that the user can more accurately and intuitively observe the doneness of the food on the grills.

### BRIEF DESCRIPTION OF THE DRAWINGS

FIG. 1 is an overall schematic structural diagram according to an embodiment of the present application.

FIG. 2 is an overall schematic structural diagram according to an embodiment of the present application, mainly showing grills.

FIG. 3 is an overall schematic structural diagram according to an embodiment of the present application, mainly showing a maintenance chamber and a heating tube rear cover.

FIG. 4 is a schematic structural diagram showing a heating tube for smoking, a heating tube for roasting, a smoking box and a temperature sensor according to an embodiment of the present application.

FIG. 5 is a partial schematic structural diagram according to an embodiment of the present application, mainly showing an oil guide plate.

FIG. 6 is a partial schematic structural diagram according to an embodiment of the present application, mainly showing an adjustment port.

FIG. 7 is a partial schematic structural diagram according to an embodiment of the present application, mainly showing a power board assembly.

### DETAILED DESCRIPTION

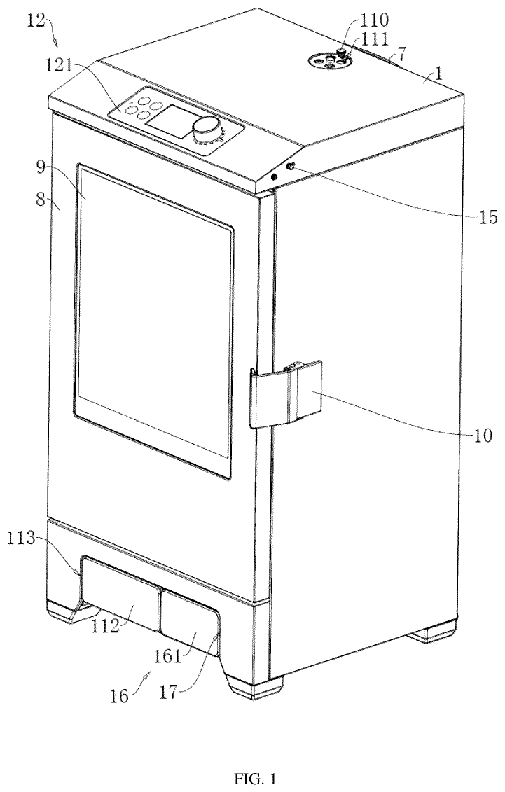

The present application is described in further detail below referring to FIGS. 1-7.

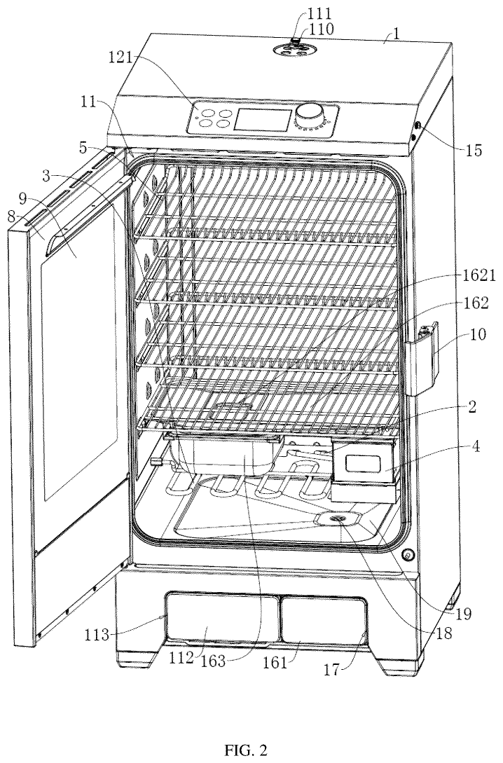

The present application discloses an electric smoking oven with independent smoke control. Referring to FIGS. 1 and 2, the electric smoking oven with independent smoke control includes an oven body 1, a heating tube for smoking 2, a heating tube for roasting 3, a smoking box 4, and a plurality of grills 5.

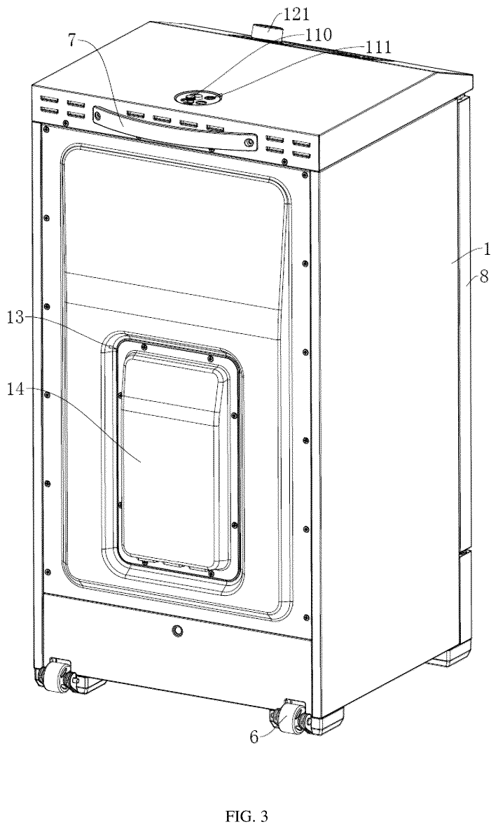

Referring to FIGS. 1 and 3, rollers 6 are rotatably connected to the bottom of the oven body 1, an axis of the roller 6 is parallel to a length direction of the oven body 1, and the roller surface of the roller 6 is in rolling contact with the ground, thereby replacing sliding friction with rolling friction to facilitate the movement of the oven body 1 by a user. A rear handle 7 is fixed on the surface of the oven body 1 via a bolt, a user holds the rear handle 7 and moves the oven body 1, by which the rear handle 7 provides a force application point for the user, thereby further facilitating the movement of the oven body 1 by the user.

Referring to FIGS. 1 and 2, the oven body 1 has a roasting chamber 11 for smoking and roasting food. A door body 8 for covering the roasting chamber 11 is rotatably connected to the surface of the oven body 1, a rotation axis of the door body is parallel to the height direction of the oven body 1, and a peripheral outer wall of the door body 8 abuts against the inner wall of the roasting chamber 11 to form a seal. A glass window 9 is embedded in the surface of the door body 8, through which a user can observe the roasting and smoking status of the food in the roasting chamber 11 without opening the door body 8.

Referring to FIGS. 1 and 2, a door lock 10 is rotatably coupled to the surface of the oven body 1, and a rotation axis of the door lock 10 is parallel to the height direction of the oven body 1. When the peripheral outer wall of the door body abuts against the inner wall of the roasting chamber 11 to form the seal, the door lock 10 is rotated in a direction close to the door body 8, to clamp the door body 8 between the surface of the door lock 10 and the surface of the oven body 1, whereby the door body 8 is not easily detached from the inner wall of the roasting chamber 11, thereby improving the sealing stability of the door body 8 against the roasting chamber 11.

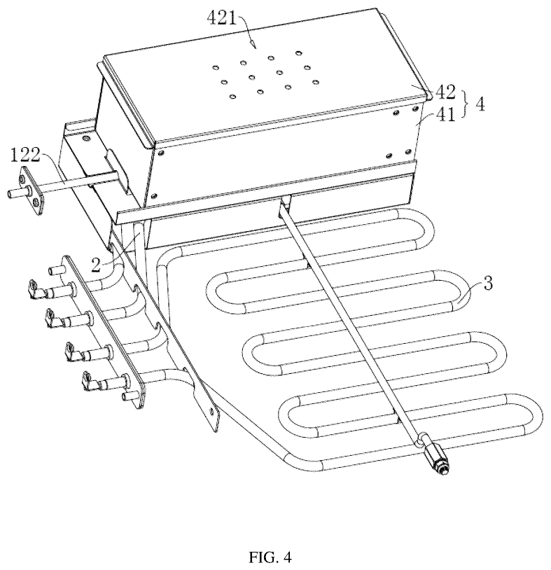

Referring to FIGS. 2 and 4, the plurality of grills 5 are inserted into the inner wall of the roasting chamber 11 at intervals in sequence, and the outer walls of the grills 5 abut against the inner wall of the roasting chamber 11. The arrangement direction of the grills 5 is parallel to the height direction of the oven body 1, and the surfaces of the grills 5 are used for placing food. The heating tube for roasting 3 and the heating tube for smoking 2 are fixed to the inner wall of the roasting chamber 11 at intervals, and a heating end of the heating tube for roasting 3 faces the plurality of grills 5 so as to heat the food on the grills 5. The smoking box 4 includes a box body 41 and a box cover 42, where a smoke-producing material is stored in an inner chamber of the box body 41, the box cover 42 is slidably connected to a surface of the box body 41 for covering the box body 41. A plurality of smoke outlets 421 are defined at intervals on the surface of the box cover 42, the smoke outlets 421 communicate with the inner chamber of the box body 41, and smoke generated by the heated smoke-producing material in the box body 41 is discharged through the smoke outlets 421. The heating end of the heating tube for smoking 2 is fixed to the box body 41 by means of a bolt, to heat the smoke-producing material in the box body 41.

Referring to FIGS. 2 and 4, the oven body 1 is equipped with a control assembly 12 for controlling a smoke production duration of the smoking box 4. The control assembly 12 includes a control panel 121 and a temperature sensor 122. The control panel 121 is fixed to a top surface of the oven body 1 via bolts, and the control panel 121 is electrically connected to the heating tube for smoking 2, so as to set the smoking time and control the on/off switching and heating temperature of the heating tube for smoking 2 through the control panel 121. The temperature sensor 122 is fixed to the inner wall of the roasting chamber 11, and the detection end of the temperature sensor 122 abuts against a bottom of the box body 41. The temperature sensor 122 is electrically connected to the control panel 121, and the temperature sensor 122 can detect the temperature in the box body 41 in real time and transmit the temperature to the control panel 121. When the food on the grills 5 needs to be smoked, an operator sets a smoking time on the control panel 121, so that the control panel 121 controls the heating tube for smoking 2 to turn on and heat the smoke-producing material in the smoking box 4. The temperature sensor 122 detects the temperature of the smoking box 4 in real time and transmits the temperature to the control panel 121, and the control panel 121 compares the temperature of the smoking box 4 with a preset value and controls the heating temperature of the heating tube for smoking 2, so as to achieve the stability of the smoke concentration in the roasting chamber 11.

Referring to FIGS. 2 and 3, the side wall of the oven body 1 away from the door body 8 is configured with a maintenance chamber 13 in communication with the roasting chamber 11, and the maintenance chamber 13 faces the heating tube for roasting 3 and the heating tube for smoking 2. A heating tube rear cover 14 for covering the maintenance chamber 13 is fixed on the surface of the oven body 1 via a bolt, and the cover surface of the heating tube rear cover 14 abuts against the surface of the oven body 1 and covers the maintenance chamber 13, so that external impurities cannot easily enter the roasting chamber 11 via the maintenance chamber 13 to interfere with the roasting and smoking treatment of the food, thereby ensuring the roasting and smoking stability of the food. When it is necessary to repair or replace the heating tube for roasting 3 or the heating tube for smoking 2, the bolt is unscrewed to remove the heating tube rear cover 14 from the oven body 1, thereby facilitating the repair and replacement of the heating tube for roasting 3 and the heating tube for smoking 2 and extending the service life of the electric smoking oven.

Referring to FIG. 1, a meat temperature probe connector 15 is connected to the surface of the oven body 1, and a detection end of the meat temperature probe is inserted into the meat temperature probe connector 15 for measuring the internal temperature of the food on the grills 5, so that a user can more accurately and intuitively control the doneness of the food on the grills 5, so that the food on the grills 5 is not easily burnt, thereby improving the flavor of the food.

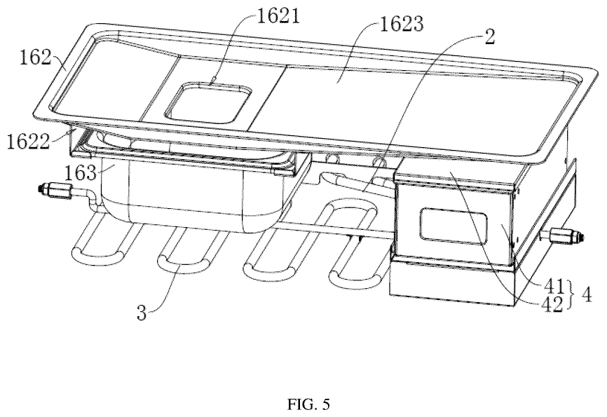

Referring to FIGS. 2 and 5, an oil storage assembly 16 is installed on the oven body 1 for collecting greasy dirt on the grills 5. The oil storage assembly 16 includes a greasy dirt collection box 161, an oil guide plate 162, and a water basin 163. The surface of the oven body 1, on which the door body 8 is provided, is configured with a sliding chamber 17, the greasy dirt collection box 161 is slidable in the sliding chamber in a sliding direction, which is parallel to the width direction of the oven body 1. An inner wall of the roasting chamber 11 close to the greasy dirt collection box 161 is formed with an oil discharge hole 18, an orifice of the oil discharge hole 18 faces the bottom of the grills 5, the axis of the oil discharge hole 18 is parallel to the height direction of the oven body 1, and the oil discharge hole 18 extends through the inner wall of the roasting chamber 11 along its own axis and communicates with the sliding chamber 17. When the greasy dirt collection box 161 slides along the inner wall of the sliding chamber 17 toward the oven body 1, a box opening of the greasy dirt collection box 161 faces the oil discharge hole 18 and communicates with it. The greasy dirt of the food on the grills 5 falls to the bottom wall of the roasting chamber 11 under its own weight and enters an inner cavity of the greasy dirt collection box 161 through the oil discharge hole 18 and the box opening of the greasy dirt collection box 161 along the bottom wall of the roasting chamber 11, thereby achieving automatic collection of the greasy dirt. When the inner cavity of the greasy dirt collection box 161 is filled with greasy dirt, the greasy dirt collection box 161 is driven to slide along the inner wall of the sliding chamber 17 in a direction away from the oven body 1 so as to be separated from the oven body 1, thereby facilitating cleaning of the oil in the greasy dirt collection box 161.

Referring to FIGS. 2 and 5, the inner wall of the roasting chamber 11 with the oil discharge hole 18 is formed with a buffer surface 19, the buffer surface 19 flares outward in a direction to the axis of the oil discharge hole 18, and the buffer surface 19 guides the greasy dirt to enter the inner cavity of the greasy dirt collection box 161 through the oil discharge hole 18, so that the greasy dirt is not easily accumulated on the buffer surface 19, thereby improving the collection efficiency of the greasy dirt.

Referring to FIGS. 2 and 5, an oil guide plate 162 is provided in the roasting chamber 11, the plate surface of the oil guide plate 162 abuts against the inner wall of the roasting chamber 11. The oil guide plate 162 is located on a side of the heating tube for roasting 3 facing the grills 5, and the plate surface of the oil guide plate 162 facing the grills 5 is configured with an oil guide hole 1621. The axis of the oil guide hole 1621, which extends through the oil guide plate 162 along the axis thereof, is parallel to the height direction of the oven body 1. The plate surface of the oil guide plate 162 facing the heating tube for roasting 3 is configured with a positioning chamber 1622 in which the water basin 163 is slidable parallel to the width direction of the oven body 1. When the water basin 163 slides along the inner wall of the positioning chamber 1622 in a direction to the oil guide hole 1621, the basin opening of the water basin 163 faces the oil guide hole 1621 until communicating therewith, and the outer peripheral surface of the water basin 163 abuts against the inner wall of the positioning chamber 1622, thereby realizing the detachable connection of the water basin 163 and the oil guide plate 162.

Referring to FIGS. 2 and 5, when the basin opening of the water basin 163 faces and communicates with the oil guide hole 1621, the greasy dirt of the food on the grills 5 falls by its own weight onto the plate surface of the oil guide plate 162 and enters the inner cavity of the water basin 163 through the oil guide hole 1621. Since the density of the greasy dirt is less than the density of the water, the oil floats on the water surface in the water basin 163. When the greasy dirt accumulated in the water basin 163 overflows, the oil falls onto the buffer surface 19 under its own gravity, and the buffer surface 19 guides the greasy dirt into the inner cavity of the greasy dirt collection box 161 through the oil discharge hole 18, so as to realize accurate collection of the greasy dirt.

Referring to FIGS. 2 and 5, the plate surface of the oil guide plate 162 facing the grills 5 is formed with an oil guide surface 1623 that flares outward in the axial direction of the oil guide hole 1621. When the greasy dirt of the food on the grills 5 falls by its own weight onto the oil guide surface 1623, the oil guide surface 1623 guides the greasy dirt into the oil guide hole 1621 so that the greasy dirt is not easily caught on the plate surface of the oil guide plate 162, thereby improving the collection efficiency of the greasy dirt.

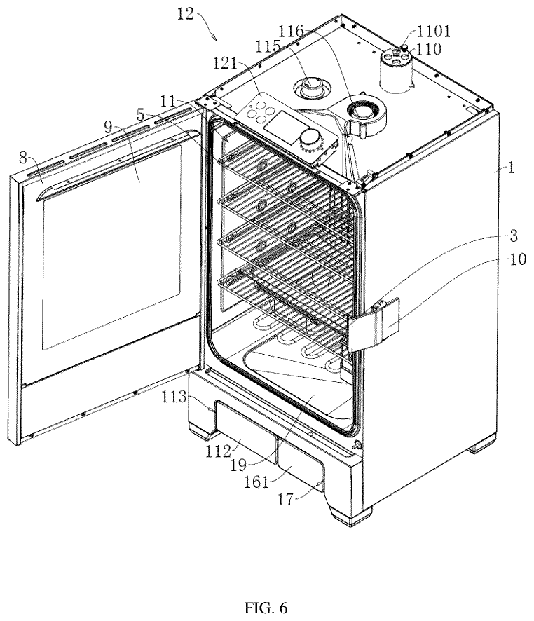

Referring to FIGS. 2 and 6, an adjustment plate 110 is rotatably coupled to the surface of the oven body 1, and a rotation axis of the adjustment plate 110 is parallel to the height direction of the oven body 1. The oven body 1 is configured with a plurality of exhaust vents 111 uniformly distributed at intervals around the rotation axis of the adjustment plate 110, and the exhaust vents communicate with the roasting chamber 11. The adjustment plate 110 is configured with a plurality of adjustment ports 1101 uniformly distributed at intervals around the axis of the adjustment plate 110, and the adjustment ports 1101 extend through the adjustment plate 110 and communicate with the exhaust vents 111. When it is necessary to control the flow rate of the gas discharged from the oven body 1 to be large, the adjustment plate 110 is driven to rotate on the surface of the oven body 1, so that the communication area between the adjustment port 1101 and the exhaust vent 111 is changed, thereby achieving accurate control of the flow rate of the gas discharged from the oven body 1.

Referring to FIG. 1, the surface of the oven body 1 with the door body 8, is slidably coupled with a tool box 112, which is used for receiving tools. The surface of the oven body 1 with the door body is configured with a storage compartment 113 in which the tool box 112 is slidable in a direction parallel to the width direction of the oven body 1. When the tool box 112 slides along the inner wall of the storage compartment 113 in a direction away from the oven body 1, the tool box 112 and the oven body 1 are separated, so that it is convenient for a user to place a tool into the inner cavity of the tool box 112, thereby further improving the user's ease of using the electric smoking oven.

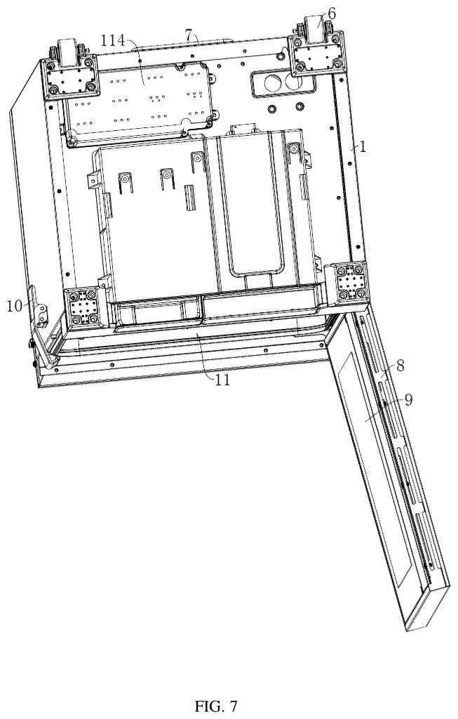

Referring to FIGS. 6 and 7, the power board assembly 114 is embedded in the top of the oven body 1 so that the power board assembly 114 is not easily damaged by an external impact, thereby extending the service life of the electric smoking oven. A heat dissipation fan 116 is embedded in the top of the oven body 1 and drives the air flow of the oven body 1 to reduce the temperature in the oven, so that the oven body 1 will not be damaged by running at a high temperature for a long time, thereby ensuring the stable operation of the electric smoking oven.

Referring to FIG. 6, an illumination light 115 is embedded in the top of the oven body 1, and the illumination light 115 emits light after being energized, so that a user can use the electric smoking oven conveniently outdoors at evening, further improving the ease of use of the electric smoking oven.

The implementation principle of the electric smoking oven with independent smoking control in the embodiments of the present application is as follows. When a user performs a roasting and smoking operation on food using the electric smoking oven, a variety of food is sequentially placed on the surface of the grills 5 at intervals, the door body 8 is rotated in a direction to the roasting chamber 11 until an outer peripheral surface of the door body 8 abuts against the inner wall of the roasting chamber 11 to form a seal, while the door lock 10 is rotated in a direction to the door body 8 until the end surface of the door lock 10 and the surface of the oven body 1 clamp the door body 8 therebetween, thereby improving the sealing of the door body 8 against the roasting chamber 11. The user sets a smoking time required by cooking the food through the control panel 121, the control panel 121 controls the heating tube for smoking 2 to start and heat the smoke-producing material in the smoking box 4, the temperature sensor 122 detects the temperature of the smoking box 4 in real time and transmits the temperature to the control panel 121, and the control panel 121 compares the temperature of the smoking box 4 with a preset value and controls the heating temperature of the heating tube for smoking 2 so as to achieve a stable smoking concentration in the roasting chamber 11, and accurately controls the time when smoking starts and the amount of smoking output in the roasting process of the food to maintain a uniform amount of smoke throughout the roasting process, thereby improving the taste of the roasted food.

The above are the optional embodiments of the present application, and the protection scope of the present application is not limited thereby, therefore, equivalent changes made according to the structure, shape and principle of the present application shall be covered by the protection scope of the present application.

### LIST OF REFERENCE SIGNS

1 oven body
11 roasting chamber
13 maintenance chamber
17 sliding chamber
18 oil discharge hole
19 buffer surface
111 exhaust vent
113 storage compartment
2 heating tube for smoking
3 heating tube for roasting
4 smoking box
41 box body
42 box cover
421 smoke outlet
5 grill
6 roller
7 rear handle
8 door body
9 glass window
10 door lock
12 control assembly
121 control panel
122 temperature sensor
14 heating tube rear cover
15 meat temperature probe connector
16 oil storage assembly
161 greasy dirt collection box
162 oil guide plate
1621 oil guide hole
1622 positioning chamber
1623 oil guide surface
163 water basin
110 adjustment plate
1101 adjustment port
112 tool box
114 power board assembly
115 illumination light
116 heat dissipation fan

What is claimed is:

1. An electric smoking oven with independent smoke control, comprising an oven body, a heating tube for smoking, a heating tube for roasting, a smoking box and a plurality of grills, wherein the oven body has a roasting chamber, the plurality of grills are connected to an inner wall of the roasting chamber at intervals, the heating tube for roasting and the heating tube for smoking are connected to the inner wall of the roasting chamber at intervals, a heating end of the heating tube for roasting faces the plurality of grills to heat food on the plurality of grills, and a heating end of the heating tube for smoking is connected to the smoking box to heat a smoke-producing material in the smoking box.

2. The electric smoking oven with independent smoke control according to claim 1, wherein the oven body is connected with a control assembly comprising a control panel and a temperature sensor, the control panel is connected to a surface of the oven body, the control panel is electrically connected to the heating tube for smoking to set smoking time and control on/off switching and a heating temperature of the heating tube for smoking, the temperature sensor is connected to the inner wall of the roasting chamber, a detection end of the temperature sensor abuts against an outer wall of the smoking box, the temperature sensor is electrically connected to the control panel, and the temperature sensor is configured for detecting a temperature of the smoking box in real time and transmitting the temperature of the smoking box to the control panel.

3. The electric smoking oven with independent smoke control according to claim 1, wherein a meat temperature probe connector is connected to a surface of the oven body, and a detection end of a meat temperature probe is inserted into the meat temperature probe connector to measure an internal temperature of the food.

4. The electric smoking oven with independent smoke control according to claim 1, wherein a maintenance chamber is formed in a side wall of the oven body, the maintenance chamber communicates with the roasting chamber and faces the heating tube for roasting and the heating tube for smoking, and a heating tube rear cover is fixed on a surface of the oven body via a bolt for covering the maintenance chamber.

5. The electric smoking oven with independent smoke control according to claim 1, wherein an adjustment plate is rotatably connected to a surface of the oven body, the oven body is configured with a plurality of exhaust vents at intervals around a rotation axis of the adjustment plate, the plurality of exhaust vents communicate with the roasting chamber, the adjustment plate is configured with a plurality of adjustment ports at intervals around the rotation axis of the adjustment plate, and the plurality of adjustment ports extend through the adjustment plate and communicate with the plurality of exhaust vents.

6. The electric smoking oven with independent smoke control according to claim 1, wherein the oven body is connected with an oil storage assembly comprising a greasy dirt collection box, a sliding chamber is formed in the oven body, the greasy dirt collection box is slidable in the sliding chamber, an oil discharge hole is formed in a bottom wall of the roasting chamber facing the plurality of grills, the oil discharge hole communicates with the sliding chamber, a box opening of the greasy dirt collection box faces the oil discharge hole, and the oil discharge hole and the box opening of the greasy dirt collection box are so configured, that greasy dirt of the food on the plurality of grills enters the greasy dirt collection box through the oil discharge hole and the box opening of the greasy dirt collection box.

7. The electric smoking oven with independent smoke control according to claim 6, wherein the oil storage assembly further comprises an oil guide plate and a water basin, the oil guide plate is connected to the inner wall of the roasting chamber, the oil guide plate is located on a side of the heating tube for roasting facing the plurality of grills, the oil guide plate is configured with an oil guide hole extending through the oil guide plate, the water basin is slidably connected to a first plate surface of the oil guide plate facing the heating tube for roasting, a basin opening of the water basin faces the oil guide hole, and the water basin and the oil guide hole are so configured, that the greasy dirt of the food on the plurality of grills enters the water basin through the oil guide hole along a second plate surface of the oil guide plate, and after the greasy dirt accumulated in the water basin overflows, the greasy dirt enters the greasy dirt collection box via the oil discharge hole and the box opening of the greasy dirt collection box.

8. The electric smoking oven with independent smoke control according to claim 7, wherein the second plate surface of the oil guide plate facing the plurality of grills is further formed with an oil guide surface, and the oil guide surface flares outward in an axial direction of the oil guide hole for guiding the greasy dirt into the oil guide hole.

9. The electric smoking oven with independent smoke control according to claim 7, wherein the bottom wall of the roasting chamber is further formed with a buffer surface, and the buffer surface flares outward in an axial direction of the oil discharge hole for guiding the greasy dirt into the oil discharge hole.

10. The electric smoking oven with independent smoke control according to claim 1, wherein a tool box is slidably connected to a surface of the oven body, and an inner cavity of the tool box is configured for storing a tool.
